(19) United States
(12) Patent Application Publication
(10) Pub. No.: US 2003/0106267 A1
(43) Pub. Date: Jun. 12, 2003

(54) System for driving and guiding a window pane sliding in a frameless door panel of a motor vehicle

(76) Inventor: Bernard Dron, Puteaux (FR)

Correspondence Address: Stephen B. Salai, Esq., Harter, Secrest & Emery LLP, 1600 Bausch & Lomb Place, Rochester, NY, 14604-2711, US

(21) Appl. No.: 10/221,382

(22) PCT Filed: Jan. 11, 2002
(86) PCT No.: PCT/FR02/00110

(30) Foreign Application Priority Data
Jan. 11, 2001 (FR) 0100317

(51) Int. Cl. E05F 11/38

(52) U.S. Cl. 49/352; 49/349; 49/348; 49/374

(57) ABSTRACT

The invention concerns a system wherein the door panel (2) is not provided with panel slide rails and at least one of the members guiding the sliding window pane (3) comprises part (4a-4b) of a standard framing glass run, arranged in the panel so that it covers in the usual manner a lateral edge of the sliding window pane (3).

### FIELD OF THE INVENTION

This invention relates to a system for driving and guiding a sliding window in a frameless door shell of a motor vehicle.

### DESCRIPTION OF RELATED ART

Various types of such systems—known as “window control switch systems” for short—have been proposed in the past.

Many years ago, the devices used for this purpose had movable arms, mounted so as to pivot in response to a motorized mechanism inside the door shell; one end of this device was mounted so as to slide along a runner rigidly incorporated into the window at its base. This system also included lateral guiding mechanisms on the windows, called “shell runners.”

However, such devices were abandoned, not only because they were costly, but also because they were also heavy, rigid and, above all, they were too bulky, occupying most of the available space within the door shell.

In order to eliminate these drawbacks, the use of window control switch systems was proposed. In these systems, a motorized cable drives the sliding window.

In order for the window to slide properly, it must be guided at two different points, and various devices have been proposed for meeting this requirement.

In some devices used, the motorized cable was attached to the base of the sliding window; one point on the window was guided by a single rail placed inside the door shell and positioned in the direction of the window's movement, while a second guiding point was at the top of the window, generally near the center pillar of the chassis of the vehicle.

This system was abandoned, for esthetic reasons (the rail was too large) and also because it had a limited lifespan, in light of the significant amount of wear it received, but most of all because it was still necessary to use the two shell runners that were intended primarily to guide the lateral edges of the window, and, as a result, the overall cost was excessively high.

Subsequently, still with the aim of using only a single guide rail within the shell, it was proposed that a rigid plate be attached to the lower portion of the window, which would then be used to guide this plate by means of the rail at two vertically aligned points.

However, the two guide points were only a short distance apart, since the plate attached to the window was necessarily small in size, particularly in the direction in which the window moved, and this created stress that reduced the lifespan of the device. In addition, as with the preceding system, it was generally necessary to use two shell runners.

With the aim of eliminating these shell runners, it was then proposed to attach the motorized cable at two widely spaced points along the width of the sliding window, and to retain the two attachment points by means of two separate guide rails housed in the door shell and positioned in the direction of the window's movement.

In theory, if the guide rails are sufficiently close to the window's lateral edges, the shell runners can be eliminated, thereby reducing the weight and cost of the system. In practice, however, the guide rails can only be placed sufficiently apart if there is sufficient space available within the door frame, which at present is rarely the case, since the side speakers for the vehicle's radio equipment occupy a great deal of space in the door shell. As a result, the two guide rails are frequently too close together and it becomes necessary to add one or two segments of a shell runner, which is precisely what this system was meant to eliminate.

In addition, problems with corrosion were encountered during actual use and any movement of the window created noise, and the solutions adopted to eliminate these drawbacks, systems of this type became heavier, more complex and, unfortunately, more expensive.

Moreover, it is known that when vehicle doors include a frame for the sliding window and shell runners are used, these runners are not perfectly aligned with the runners fitted into the window frame, which creates serious problems.

### BRIEF SUMMARY OF THE INVENTION

On the basis of this last observation, the Applicant has already, with regard to doors of this type, envisaged how to overcome the disadvantages encountered in the past in systems for driving retractable windows, by replacing the rails used in past systems either with components that extend the so-called “runner” sections fitted into the window frame, which are incorporated into them, or with components of such frame runners that are placed so as to extend the frame runners, but remain separate from them, and the assembly parts that are normally attached to the guide rail or rails are in this case attached directly to runner components.

It will be recalled that in engineering applications, a “runner” is a sectional piece for window frames that is composed of elastomeric or thermoplastic material, usually extruded, which is attached to the window frame; one portion, with a U-shaped section, covers the window periphery for the purpose of guiding the window during its movement and creating a seal when the window is in closed position.

In her application no. 00 012 431 for a French patent, filed on Sep. 29, 2000, the Applicant proposed a system for driving and guiding a retractable sliding window within a chassis shell of a motor vehicle, and in particular in a door shell having a window frame, said system including within the shell:

An endless cable incorporated at two points into the sliding window and capable of driving the window during its movement in an appropriate direction,

A motor for driving this cable in one direction or the other,

Return pulleys for this cable,

Two mechanisms for guiding the sliding window, this system being characterized in that the door shell has no shell runners and at least one of the mechanisms for guiding the sliding window includes either a component of the window frame runner, which is part of this runner and extends it within the door shell, or a component of such a window frame runner placed so as to extend it, but separate from it, said runner component in either case covering the corresponding edge of the window in the usual manner.

In the course of pursuing research into window control switch systems of this kind, the Applicant established that a system of this type can be simply and advantageously adapted to driving and guiding a sliding window in a frameless door on a motor vehicle. Consequently, the purpose of the present invention is to provide a system for driving and guiding a retractable sliding window within a chassis shell of a frameless door on a motor vehicle, said system including within the shell:

An endless cable incorporated at two points into the sliding window and capable of driving the window during its movement in an appropriate direction,

A motor for driving this cable in one direction or the other,

Return pulleys for this cable,

Two mechanisms for laterally guiding the sliding window, This system being characterized in that the door shell has no shell runners and that at least one of the mechanisms for guiding the sliding window includes a component of a typical window frame runner, arranged within the compartment in such a way that it covers a lateral edge of the sliding window in the usual manner.

The component of the typical window frame runner housed inside the shell is preferably rigid or made rigid at certain points.

At least some of the return pulleys for the window's drive cable may advantageously be supported by brackets that are attached to this part of the runner and used to fix the entire system in place.

The two mechanisms for guiding the sliding window inside the shell each preferably include a component of a typical window frame runner, these components being placed to the front and rear of the vehicle door respectively.

The system according to the invention can also include a guide mechanism made up of a component of a window frame runner of this type and a second guide mechanism that includes a guide rail from past applications, offset as much as possible toward the rear or front respectively of the vehicle with respect to the vertical line representing the sliding window's center of gravity.

All of these methods of implementing the invention yield a maximum amount of space in which vehicle designers can place various equipment located within or penetrating into the door shell, such as a radio or tape-deck speaker, hand grip bar, glove compartment, safety components, etc.

Apart from this evident advantage, the system according to the invention includes the properties inherent in window frame runners: excellent guiding and sliding characteristics, resistance to wear and corrosion and at the same time, an absence of noise while the window is moving.

To simplify assembly, mounting brackets might advantageously be included on the runner components, one of which preferably has an adequate surface with which to support the drive motor for the cable.

It should be noted in this regard that the system according to the invention may be arranged on either side of the window (although it is preferably located in the interior of the vehicle) and that consequently a mounting bracket could be diagonally extended by a part that could replace or reinforce the standard anti-intruder bar on the door.

Finally, the upper interior portion of the door shell, i.e., the upper portion of the interior panel and the corresponding belt reinforcement, can be attached to the window frame runner components acting as window guide mechanisms inside the door shell, by means of mounting brackets or even directly. This would create space through which the entire pre-assembled window lift system could be installed, and it then becomes possible to produce a modular window assembly made up of the lower mounting brackets, the motor, the drive cable for the window and the window itself; the upper “beam” of the interior shell would be solidly attached in a location or even a recess established for this purpose in the door shell.

Other characteristics and advantages of the invention will emerge in the following detailed description of various methods of its implementation, provided by means of non-restrictive examples. This description will refer to the attached schematic drawings, in which:

### BRIEF DESCRIPTION OF THE DRAWINGS

FIG. 1 is a lateral elevated view of an automobile door without a frame and equipped with a version of the system in accordance with the invention, in which the two guide mechanisms are components of typical window frame runners;

FIG. 2 is analogous to FIG. 1 and shows a second automobile door without a frame and equipped with a variant of the system in accordance with the invention.

### DETAILED DESCRIPTION OF THE INVENTION

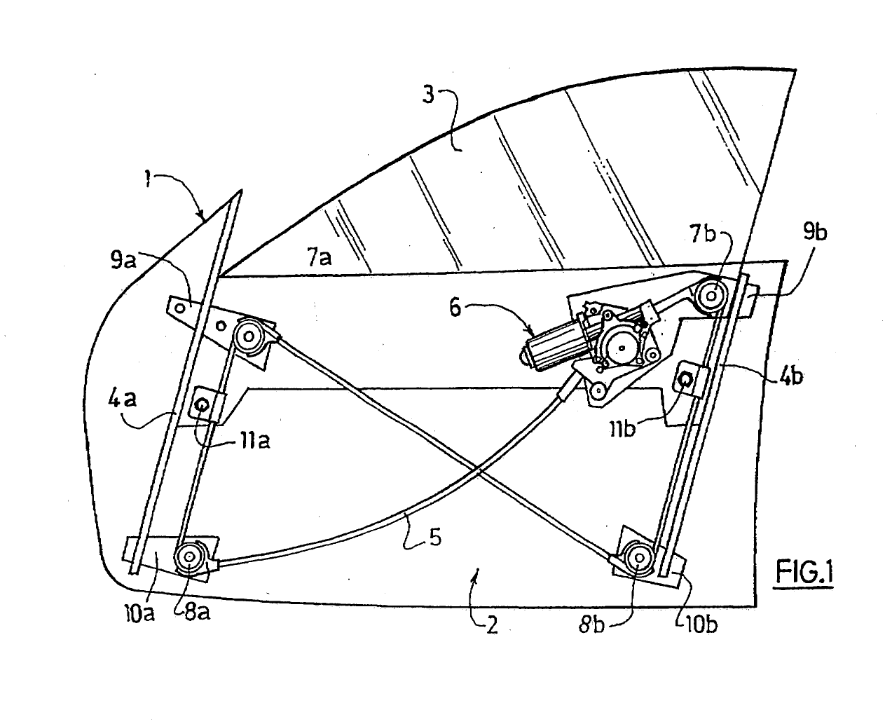

We will first make reference to FIG. 1, in which the frameless door of a motor vehicle is indicated by the number 1, the number 2 indicates the door shell, and the number 3 indicates the retractable sliding window inside the door shell.

In accordance with the invention, the guide mechanisms for the sliding-window inside the door frame 2 comprises, at the front and rear of the door, the components 4a and 4b of a typical window frame runner, i.e., as indicated above, a section that generally is installed on a sliding window frame, these runner components 4a and 4b being placed in the shell in such a position that they cover the corresponding edge of the window 3 in the usual manner.

The runner from which the components 4a and 4b extend may be any type of commonly found runner.

The window 3 is operated by an endless cable 5, made of intertwined strands, that is driven by a reversible electric motor 6, and that is rigidly incorporated into the base of the window at two points, 11a and 11b, arranged at the front and rear of the window, respectively.

The cable 5 passes over four return pulleys. Two of these, 7a and 7b, are arranged on the upper portion of the door shell, to the front and rear of the shell respectively, while the other two, 8a and 8b, are arranged on the lower portion of the door shell, at the front and rear of the shell respectively. These pulleys are supported by mounting brackets, 9a and 9b and 10a and 10b, respectively, which are attached to the upper and lower portions respectively of the components 4a and 4b of the runners arranged inside the door shell.

These mounting brackets are already commonly used in door shells to attach the individual guiding and driving elements for the window, with at least one bracket being associated with each component, which complicates assembly. Here, the number of brackets has been reduced, thereby limiting the assembly's weight and the cost of production.

In the method of producing the invention described, one of the brackets, 9b for example, is much larger in size than the others, and it supports the motor 6. Naturally, the other brackets may also be of a shape or size that would allow them to be used for additional functions within the door shell, as indicated above.

Since the sliding window 3 is guided in its movements inside the door frame solely by the components 4a and 4b of the window frame runner, without any additional guide mechanisms, and in particular without any additional runners inside the shell, maximum volume becomes available for a variety of uses inside the door shell.

If the runner is itself rigid, the brackets may be attached to this runner at each point through the injection of a rigid thermoplastic material.

If the runner is flexible (without a rigid frame), a similar attachment of brackets onto the runner is necessary, but in addition, the area between the brackets must be made at least partially rigid by means of this same method of injecting a rigid thermoplastic material.

As indicated above, it may be possible to use a single window frame component as a guide mechanism for the sliding window inside the doorframe, with the second guide mechanism consisting of a guide rail in the known manner.

In these two methods of implementing the system according to the invention, the cost proves to be significantly lower than with systems formerly used to drive sliding windows, while free space is created at specific locations within the shell.

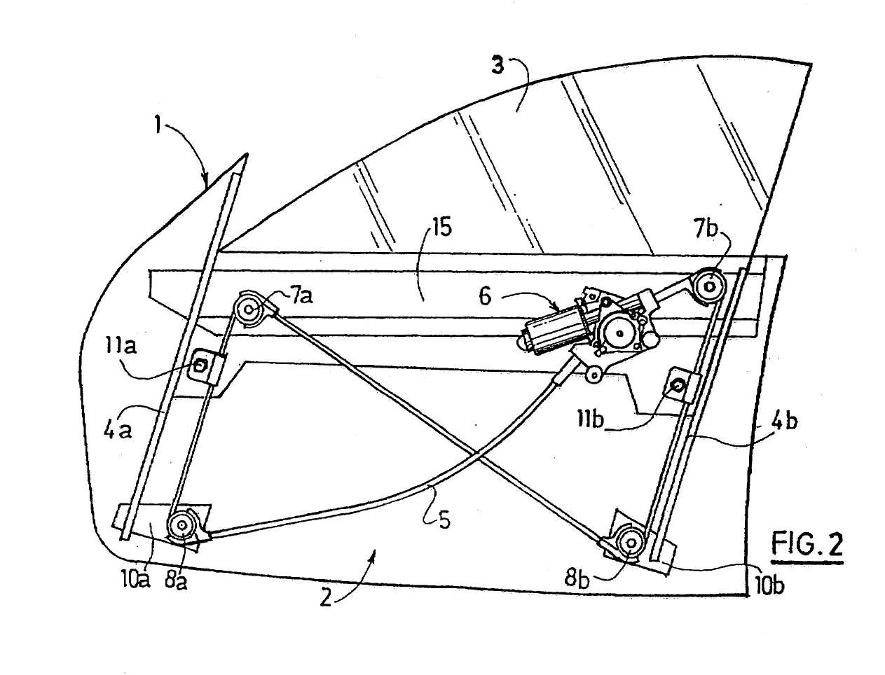

In FIG. 2, which represents a preferred method of implementing the invention, the elements described earlier are again designated by the same reference numbers.

In this method of implementing the invention, in order to make the entire window lift assembly rigid in accordance with the invention, the door's interior belt reinforcement and the protruding component 15 of the door's interior panel can advantageously be placed facing each other; in this case, the area along the edge of the door can be enlarged so as to facilitate or simply make possible the insertion and mounting of the window lift assembly, delivered entirely pre-assembled.

It will be noted that, as shown in FIG. 2, it is possible to take advantage of this rigid area and eliminate the upper mounting brackets supporting the pulleys 7a and 7b and the motor 6, if the precaution is taken of making the runners 4a and 4b and the beam formed by the existing volume around the component rigid 15 by injecting them with a rigid plastic material, with the beam itself being solidly attached at each end to a location or recess created for this purpose in the door shell.

1. System for driving and guiding a retractable sliding window (3) within a shell (2) of a frameless door on a motor vehicle, said system including within the shell:
An endless cable (5) incorporated at two points into the sliding window and capable of driving the window during its movement in an appropriate direction,
A motor (6) for driving this cable in one direction or the other,
Return pulleys (7a, 7b, 8a, 8b) for this cable,
Two mechanisms for laterally guiding the sliding window, this drive system being characterized in that the door shell (2) has no shell runners and at least one of the mechanisms for guiding the sliding window (3) includes a component (4a, 4b) of a typical window frame runner, arranged within the shell in such a way that it covers a lateral edge of the sliding window (3) in the usual manner.

2. System in accordance with claim 1, characterized in that the runner component (4a, 4b) that forms at least one of the mechanisms guiding the sliding window (3) is rigid or made rigid at certain points.

3. System in accordance with claim 1 characterized in that at least some of the return pulleys (7a, 7b, 8a, 8b) are supported by mounting brackets (9a, 9b, 10a, 10b) attached to the runner components (4a, 4b).

4. System in accordance with claim 2, characterized in that at least some of the return pulleys (7a, 7b, 8a, 8b) are supported by mounting brackets (9a, 9b, 10a, 10b) attached to the runner components (4a, 4b).

5. System in accordance with claim 1, characterized in that the motor (6) that drives the cable (5) is supported by a bracket (9b) attached to one runner component (4a, 4b) that constitutes the mechanism for guiding the sliding window.

6. System in accordance with claim 2, characterized in that the motor (6) that drives the cable (5) is supported by a bracket (9b) attached to one runner component (4a, 4b) that constitutes the mechanism for guiding the sliding window.

7. System in accordance with claim 3, characterized in that the motor (6) that drives the cable (5) is supported by a bracket (9b) attached to one runner component (4a, 4b) that constitutes the mechanism for guiding the sliding window.

8. System in accordance with claim 4, characterized in that the motor (6) that drives the cable (5) is supported by a bracket (9b) attached to one runner component (4a, 4b) that constitutes the mechanism for guiding the sliding window.

9. System in accordance with any of claim 1, characterized in that the two mechanisms (4a, 4b) for guiding the sliding window (3) inside the door shell (2) consist of a section of the typical sliding window frame runner.

10. System in accordance with any of claim 2, characterized in that the two mechanisms (4a, 4b) for guiding the sliding window (3) inside the door shell (2) consist of a section of the typical sliding window frame runner.

11. System in accordance with claim 3, characterized in that the two mechanisms (4a, 4b) for guiding the sliding window (3) inside the door shell (2) consist of a section of the typical sliding window frame runner.

12. System in accordance with claim 4, characterized in that the two mechanisms (4a, 4b) for guiding the sliding window (3) inside the door shell (2) consist of a section of the typical sliding window frame runner.

13. System in accordance with claim 6, characterized in that the two mechanisms (4a, 4b) for guiding the sliding window (3) inside the door shell (2) consist of a section of the typical sliding window frame runner. System in accordance with any of claims 1 through 4, characterized in that the two mechanisms (4a, 4b) for guiding the sliding window (3) inside the door shell (2) consist of a section of the typical sliding window frame runner.

14. System in accordance with claim 6, characterized in that the two mechanisms (4a, 4b) for guiding the sliding window (3) inside the door shell (2) consist of a section of the typical sliding window frame runner.

15. System in accordance with claim 1, characterized in that only one of the two mechanisms (4a, 4b) for guiding the sliding window (3) inside the door shell (2) consists of a section of the typical sliding window frame runner, the other guide mechanism consisting of a guide rail in the known manner.

16. System in accordance with claim 2, characterized in that only one of the two mechanisms (4a, 4b) for guiding the sliding window (3) inside the door shell (2) consists of a section of the typical sliding window frame runner, the other guide mechanism consisting of a guide rail in the known manner.

17. System in accordance with claim 3, characterized in that only one of the two mechanisms (4a, 4b) for guiding the sliding window (3) inside the door shell (2) consists of a section of the typical sliding window frame runner, the other guide mechanism consisting of a guide rail in the known manner.

18. System in accordance with claim 4, characterized in that only one of the two mechanisms (4a, 4b) for guiding the sliding window (3) inside the door shell (2) consists of a section of the typical sliding window frame runner, the other guide mechanism consisting of a guide rail in the known manner.

19. System in accordance with claim 6, characterized in that only one of the two mechanisms (4a, 4b) for guiding the sliding window (3) inside the door shell (2) consists of a section of the typical sliding window frame runner, the other guide mechanism consisting of a guide rail in the known manner.

20. System in accordance with claim 7, characterized in that only one of the two mechanisms (4a, 4b) for guiding the sliding window (3) inside the door shell (2) consists of a section of the typical sliding window frame runner, the other guide mechanism consisting of a guide rail in the known manner.

21. System in accordance with claim 8, characterized in that only one of the two mechanisms (4a, 4b) for guiding the sliding window (3) inside the door shell (2) consists of a section of the typical sliding window frame runner, the other guide mechanism consisting of a guide rail in the known manner.

22. System in accordance with claim 8, characterized in that the two mechanisms (4a, 4b) for guiding the sliding window (3) inside the door shell (2) consist of a section of the typical sliding window frame runner.
